(19) United States
(12) Patent Application Publication
(10) Pub. No.: US 2020/0080368 A1
(43) Pub. Date: Mar. 12, 2020

(54) Cordless blinds and shades lifter rods

(71) Applicant: Nicholas Francis Covello, Chicago, IL (US)

(72) Inventor: Nicholas Francis Covello, Chicago, IL (US)

(21) Appl. No.: 16/533,617

(22) Filed: Aug. 6, 2019

Related U.S. Application Data
(60) Provisional application No. 62/729,122, filed on Sep. 10, 2018.

(51) Int. Cl. E06B 9/322; E06B 9/78

(52) U.S. Cl. CPC E06B 9/322; E06B 2009/3222; E06B 9/78

(57) ABSTRACT

Lifter rod apparatuses with blind or shade material holder that permanently attach to a cordless blind or shade which includes two opposing apparatuses identical in shape and size which use two lifter rods that can be affixed to the cordless blind or shade to aid raising and lowering to the full height and extension of windows and aid users of not sufficient height to control rolling and extension of the cordless blind or shade. Using the cordless blind or shade is more convenient.

### FIELD OF THE INVENTION

The present invention relates to an attachable lifter rod apparatus with blind or shade material holder for cordless blinds and shades, and particularly to a lifter rod apparatus to control and extend various types of cordless blinds and shades.

### SUMMARY OF THE INVENTION

Therefore the primary objective of the present invention is to provide a lifter rod apparatus with blind or shade material holder for cordless blinds or shades that is adaptable to various types of cordless blinds or shades. It is installed on the bottom of the blinds or shades to aid users of not sufficient height to extend and roll the blinds and shades.

The lifter rod apparatus for a cordless blind or shade according to the invention mainly includes two opposing mechanical apparatuses identical in shape and size. Each apparatus consists of a blind or shade material holder which has a dual function as an anchoring plate for the lifter rod, rod hinge, hinge spring pin and rod holder clip to be installed on a cordless blind or shade to the blind or shade's bottom rail.

By means of the structure set forth above, the blind or shade material holder anchoring plate can be coupled with the bottom of the bottom rail of the cordless blind or shade with fastening devices selected from the group consisting of glue, tape and screws. With the blind or shade raised to allow the lifter rods to extend vertically, it then can aid users who do not have sufficient height to control rolling and extension of the cordless blind or shade. When the blind is extended downward, the lifter rods can be collapsed and clipped horizontally under the bottom rail to store and allow the blind or shade to fully extend downward. Operation is more convenient.

The foregoing, as well as additional objects, features and advantages of the invention will be more readily apparent from the following detailed description, which proceeds with reference to the accompanying drawings.

### BACKGROUND OF THE INVENTION

There are numerous types of window coverings on the market, such as blinds, pleated shades, roman shades and the like. They are mainly installed on doors and windows of houses to block sunshine and be used as adornments. Depending on user's requirements, the general window shades can be divided into cord controlled shades that are rolled and extended through a lift cord and the cordless blind or shade 10 as shown in FIG. 1 PRIOR ART. The cordless blind or shade 10 mainly included an upper rail 11 which is coupled with a retractable blind or shade 12 on a lower side. The blind or shade 12 is coupled with a lower rail 13 on the bottom. The upper rail 11 further has a control means (not shown in the drawings) located therein to couple with and control rolling or extension of the blind or shade 12.

When in use for rolling or extending the cordless blind or shade 10, first, user's hands grasp the lower rail 13 and push upwards. The control means can automatically retract the blind or shade 12 upward. To extend the cordless blind or shade 10, the hands pull the lower rail 13 downwards, and the control means can aid extending of the blind or shade. Thus there is no need to provide a lift cord for rolling and extending of the blind or shade.

In practice, user has to grasp the lower rail 13 and exert a force on the blind or shade 12 to perform operation of rolling upwards or extending downward. For users who do not have enough height and cannot reach the lower rail 13 while the blind or shade 12 is lifted to a selected elevation, rolling operation of the blind or shade is difficult. To pull the blind or shade down for extension, users have to rely on a chair or stool to reach and grasp the lower rail 13 on the bottom of the blind or shade 12. This creates a lot of trouble and inconvenience. There is still room for improvement.

### BRIEF DESCRIPTION OF THE DRAWINGS

FIG. 1 PRIOR ART is a schematic view of a conventional cordless blind or shade.

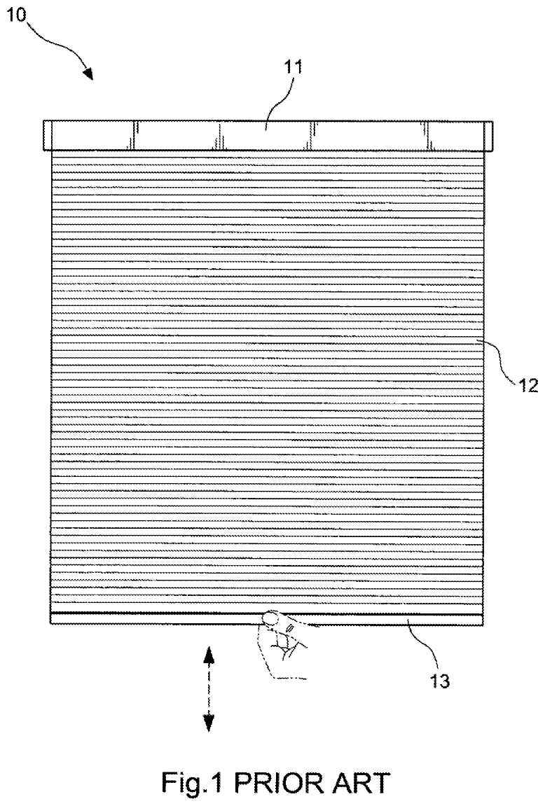

FIG. 2 is an exploded view of the present invention.

FIG. 3 is a schematic view of the present invention.

FIG. 4 is a schematic view of the present invention in a use condition.

FIG. 5 is a schematic view of the present invention in another use condition.

FIG. 6 is a schematic view of the present invention in use for controlling rolling in the upward extension of a blind or shade.

FIG. 7 is a schematic view of another embodiment of the present invention in a retracting condition.

### DETAILED DESCRIPTION OF THE PREFERRED EMBODIMENTS

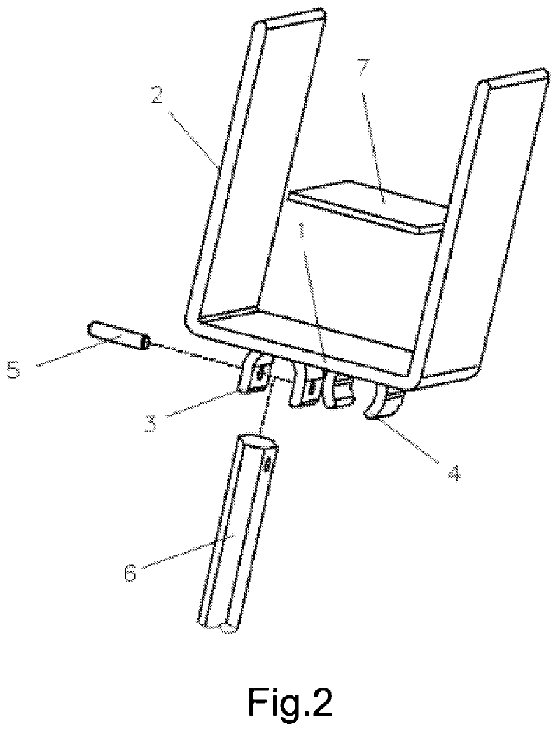

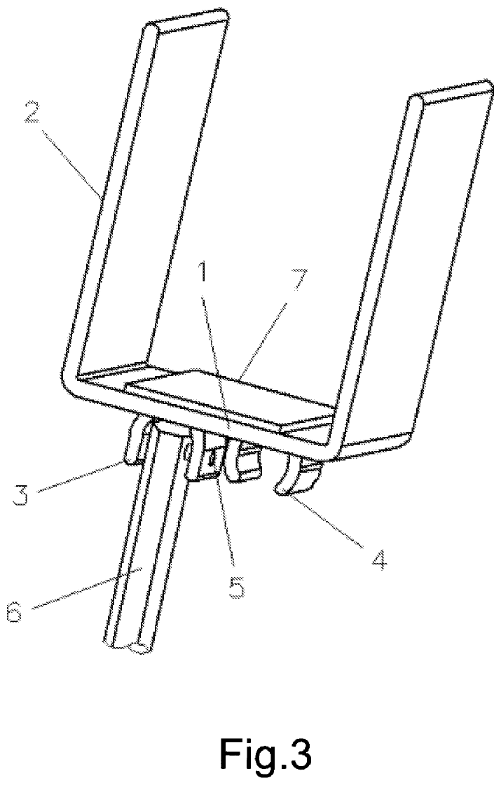

Please refer to FIGS. 2 and 3—DESCRIBING PARTS. The invention includes two opposing mechanical apparatuses identical in shape and size. Each apparatus and its control means consist of a blind or shade material holder 2 which has a dual function as an anchoring plate 1 for the lifter rod and the rod holder clip, lifter rod 6, rod hinge 3, hinge spring pin 5 and rod holder clip 4 to be installed on a cordless blind or shade 10.

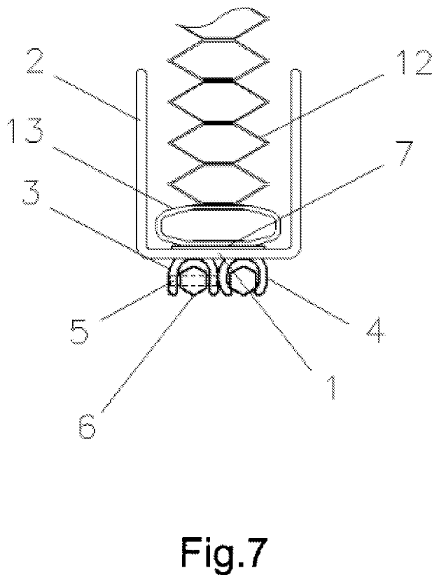

Please refer to FIGS. 3 and 7—DESCRIBING ASSEMBLY APPARATUS PARTS TO CORDLESS SHADE. By means of construction of each apparatus set forth above, to install the material holder 2 and anchoring plate 1 by means of fastening devices 7 selected from the group consisting of glue, tape and screws to the cordless blind or shade 10 to the bottom of the lower rail 13.

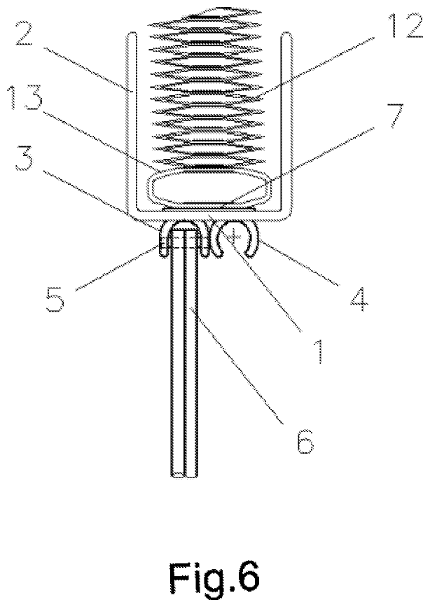

Please refer to FIGS. 2 and 6—DESCRIBE ASSEMBLY OF LIFTER RODS PARTS. By means of construction set forth above, to install each lifter rod 6 to the apparatus, the hinge spring pin 5 is inserted through both apertures in the lifter rod 6 and rod hinge 3.

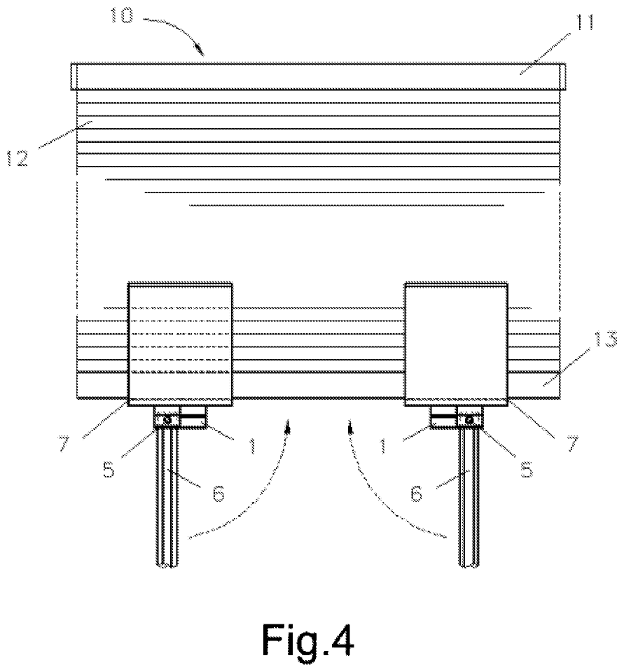

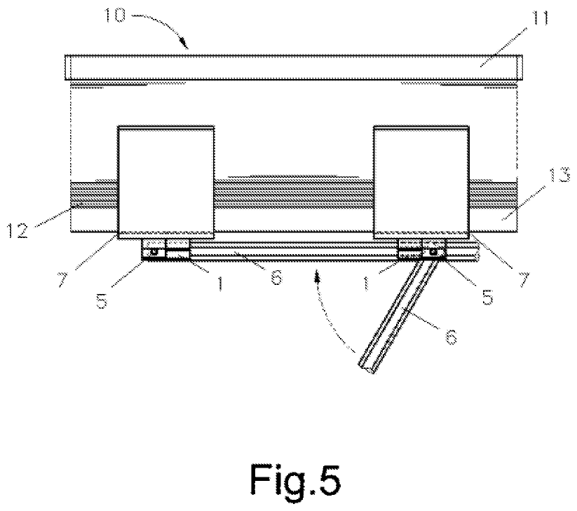

Please refer to FIGS. 4 and 5—DESCRIBING ACTION TO LIFT RODS FOR BLINDS OR SHADES UPWARD MOTION. With the cordless blind or shade extended halfway upward, and with the lifter rods 6 in a position parallel with the bottom rail 13 and clipped into the rod holder clips, the lifter rods 6 are then unclipped and pivoted downward to a vertical position perpendicular to the bottom rail 13. The lifter rods 6 being directed from the front side of the cordless blind or shade 10, the user grasps the lifter rods 6 to align the lifter rods 6 with the blind or shade material 12 to roll the blind or shade material 12 upward toward the top rail 11 of the blind or shade 10 to the full extent of the blind or shade's ability to open.

Please refer to FIGS. 4 and 5—DESCRIBING INVENTION′S BENEFITS. In short, the lifter rods for cordless blinds or shades of the invention can be installed on various types of cordless blinds or shades 10 to control rolling and extension of the plastic, metal, fabric or other material blind or shade 12. The lifter rod 6 that allows a user to extend to a selected length and aids users of not sufficient height to easily control rolling and extension of the cordless blind or shade 10. The operation is more convenient than the conventional techniques.

1. Lifter rod apparatuses that permanently attach to cordless blinds or shades, comprising two or more apparatuses and their control means consisting of a blind or shade material holder, which has a dual function as an anchoring plate for the rod hinge, rod holder clip, lifter rod and hinge spring pin; and the material holder and anchoring plate are fastenable to a cordless blind or shade by means of fastening devices selected from the group consisting of glue, tape and screws.

2. The lifter rod apparatuses of claim 1, the lifter rods and rod hinges have holes through them and are attached together with a the hinge spring pin.

3. The lifter rod apparatuses of claim 1, wherein the lifter rods placed in a parallel position to the bottom rail clipped into the rod holder clips and then unclipped and pivoted downward to a vertical position perpendicular to the bottom rail.

4. The lifter rod apparatuses of claim 2, wherein the blind or shade material holder is attached to the bottom rail of a blind or shade.

5. The lifter rod apparatuses of claim 3, wherein the lifter rods may be pivoted from a vertical position perpendicular to the bottom rail can be pivoted upward to a horizontal position parallel to the bottom rail and clipped into the rod holders when lifter rods are to be secured.
